(19) United States
(12) Patent Application Publication
(10) Pub. No.: US 2003/0193611 A1
(43) Pub. Date: Oct. 16, 2003

(54) Controller apparatus, driving apparatus, image sensing apparatus, and methods thereof

(75) Inventor: Hiroshi Yoshimura, Saitama-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/408,573

(22) Filed: Apr. 8, 2003

(30) Foreign Application Priority Data
Apr. 10, 2002 (JP) 2002-108051

(51) Int. Cl. H04N 5/225

(52) U.S. Cl. 348/374

(57) ABSTRACT

A controller apparatus determiners the rotational speed of a motor in accordance with a control signal supplied from an external device, switches the excitation scheme in accordance with the rotational speed, changes the peak current of the driving current to be supplied to the motor every time in accordance with the rotational speed, and controls the motor in accordance with the excitation scheme and peak current, thereby realizing optimum motor control according to the rotational speed in a wide range of rotational speed. When an object is sensed by a camera unit installed in a driving apparatus operated by the control method, a high-quality image sensing signal can be obtained.

### CROSS-REFERENCE TO RELATED APPLICATIONS

This application is based upon and claims the benefit of priority from the prior Japanese Patent Application No. 2002-108051, filed Apr. 10, 2002, the entire contents of which are incorporated herein by reference.

### BACKGROUND OF THE INVENTION

1. Field of the Invention

The present invention relates to a controller apparatus for a driving apparatus and, more particularly, to a controller apparatus for a driving apparatus which drives a camera unit in horizontal and vertical directions, a driving apparatus, an image sensing apparatus, and methods thereof.

2. Description of the Related Art

Recently, image processing apparatuses in various forms are becoming popular. A high-quality image output is required even in monitor camera systems that use the image processing apparatuses.

For example, a monitor camera system uses a combination dome camera or the like. The system has a mechanical structure which rotates the camera section in horizontal and vertical directions. As a motor for driving the mechanism, a stepping motor is often used. To increase the current efficiency, a bipolar stepping motor is used. For a driving circuit, a constant-current chopper scheme is used.

Various kinds of motor excitation schemes, including 2-phase excitation and microstep excitation, are used in accordance with the mechanism to be used or the product specifications. The excitation peak current is set in accordance with the maximum torque necessary at the time of driving the mechanism. Generally, the output constant current value is set in accordance with the torque in the acceleration and deceleration modes because the maximum torque is required in these modes.

As a reference for a motor control method, Jpn. Pat. Appln. KOKAI Publication No. 2001-346398 discloses a technique for controlling a driving current in accordance with the rotation state of a rotor. This prevents heat generation in the motor and saves energy.

As another reference for a motor control method, Jpn. Pat. Appln. KOKAI Publication No. 11-41989 describes an example in which a stepping motor is driven by only a microstep driving scheme.

In these motor control methods, however, both the optimum driving current value and the optimum driving scheme according to the motor driving state in each mode are not always selected. Hence, in the conventional motor control methods, the control method is not always finely optimized in accordance with the motor driving state.

### BRIEF SUMMARY OF THE INVENTION

According to an embodiment of the present invention, there is provided a controller apparatus for a rotor, comprising an excitation scheme determining section which receives a speed signal from an external device, determines a rotational speed of an external rotor on the basis of the speed signal, and determines an excitation scheme in correspondence with the rotational speed, a peak current set signal generating section which generates and outputs a peak current set signal which sets a peak current of a driving current to rotate the rotor in accordance with the rotational speed, and a control signal generating section which generates and outputs a control signal by the excitation scheme determined by the excitation scheme determining section in accordance with the rotational speed determined by the excitation scheme determining section.

### BRIEF DESCRIPTION OF THE SEVERAL VIEWS OF THE DRAWING

FIG. 1 is a graph showing the relationship between a moving speed v of a rotor, a peak current set signal P of a driving signal, and the excitation scheme of a driving current in a driving apparatus according to the present invention;

FIG. 2 is a sectional view showing an image sensing apparatus according to the present invention;

FIG. 3 is a block diagram showing an image sensing system using the image sensing apparatus according to the present invention;

FIG. 4 is a block diagram showing a driving apparatus according to the first embodiment of the present invention;

FIG. 5 is a graph showing the currents and synthetic vector of the respective winding phases of a rotor driven by the driving apparatus according to the present invention;

FIG. 6 is a graph showing the currents and synthetic vectors of the respective winding phases of the rotor driven by the driving apparatus according to the present invention in the stop state;

FIG. 7 is a timing chart showing an example of the relationship between the peak current set signal and the driving signal of the driving apparatus according to the present invention;

FIG. 8 is a timing chart showing another example of the relationship between the peak current set signal and the driving signal of the driving apparatus according to the present invention;

FIG. 9 is a block diagram showing a driving apparatus according to the second embodiment of the present invention;

FIG. 10 is a block diagram showing a driving apparatus according to the third embodiment of the present invention; and

FIG. 11 is a graph showing a method of changing the excitation scheme of the driving apparatus according to the present invention in accordance with the rotational speed.

### DETAILED DESCRIPTION OF THE INVENTION

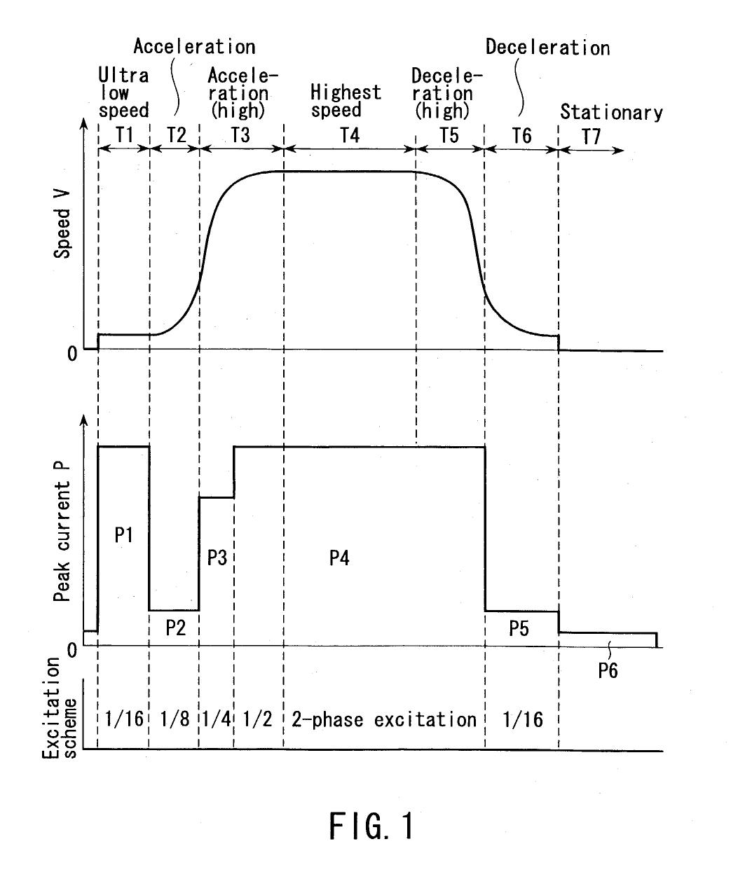

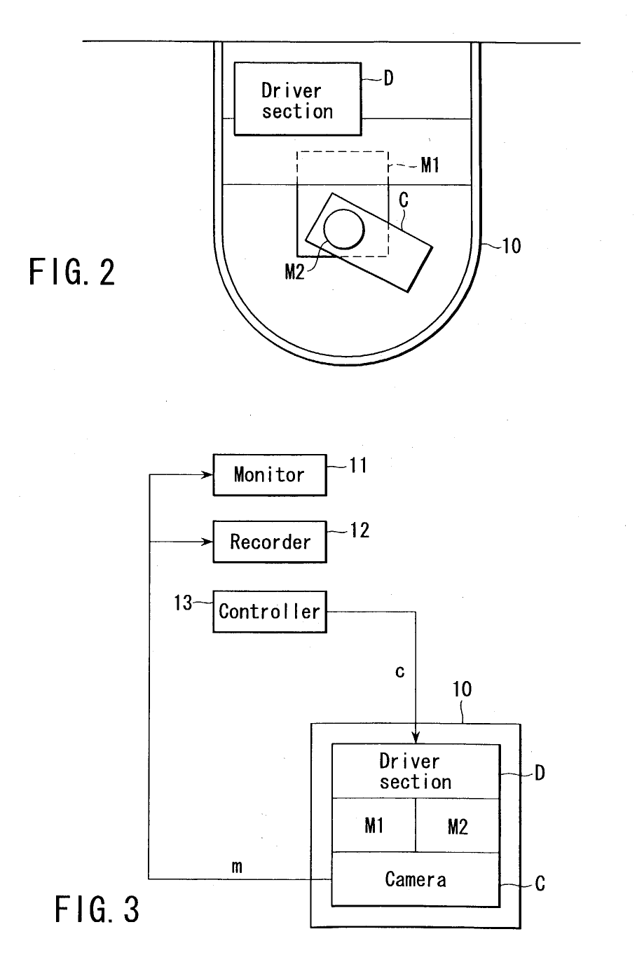

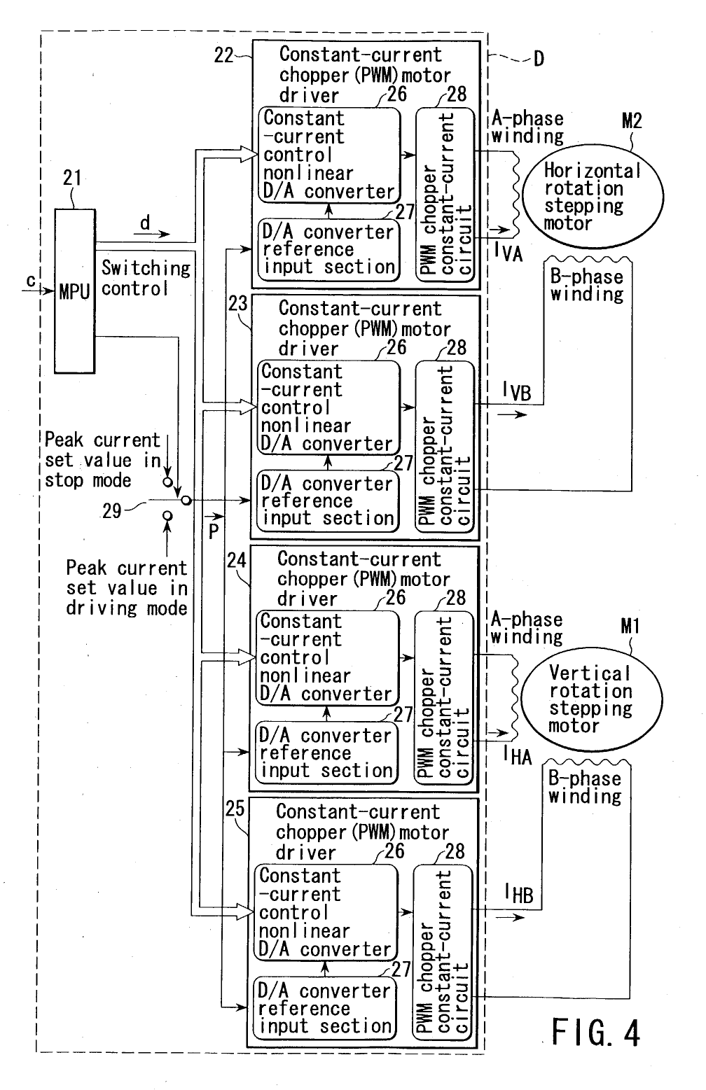

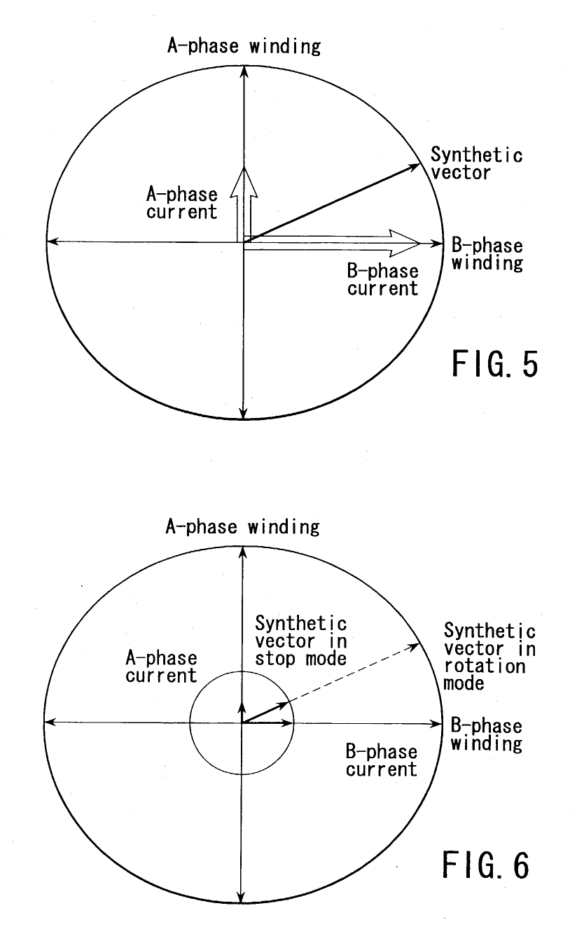

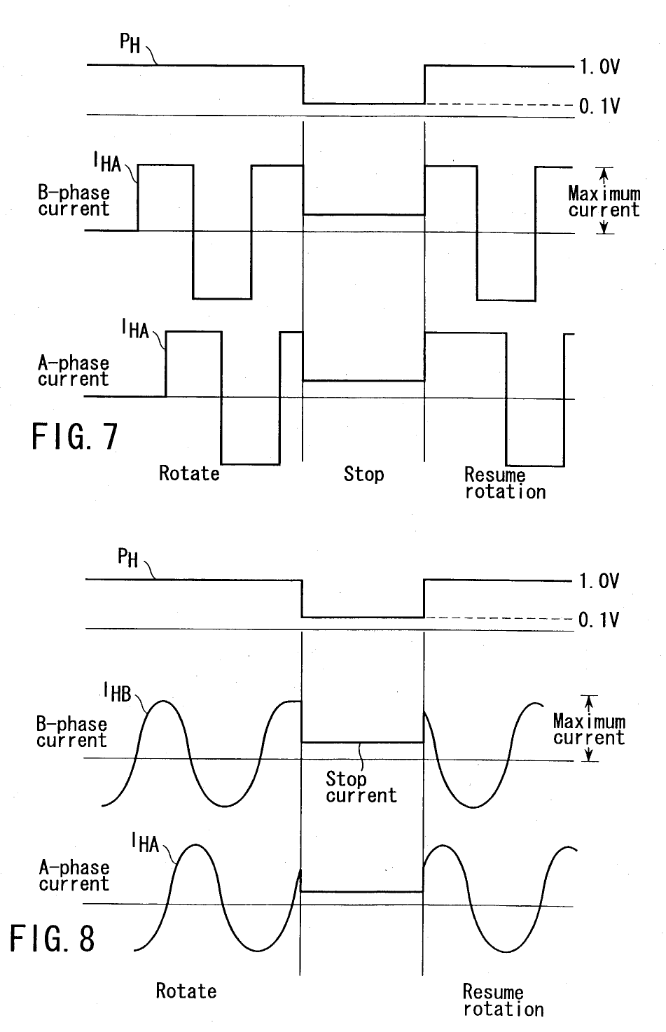

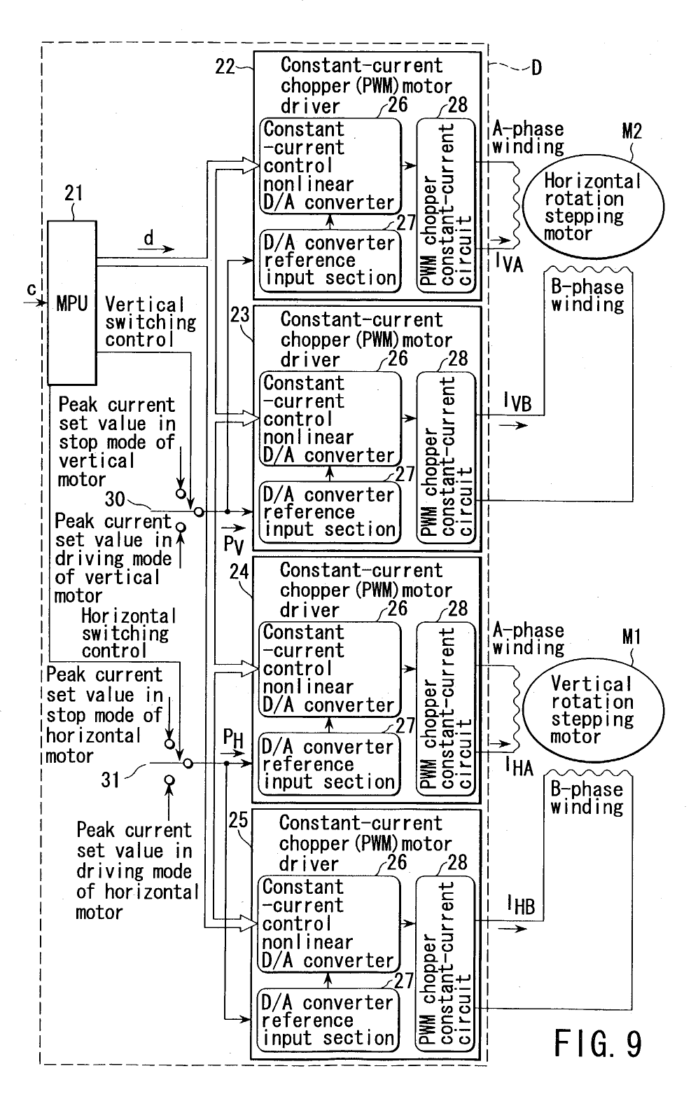

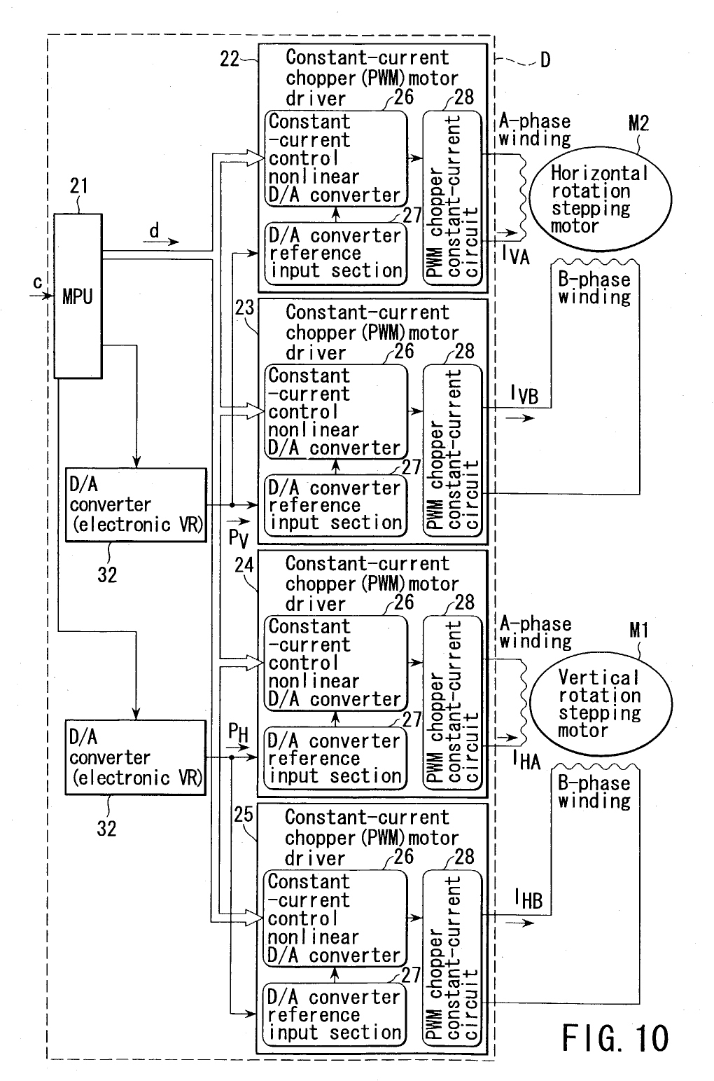

An image sensing apparatus having a camera as an embodiment of the present invention, a driving apparatus used in the image sensing apparatus, or a controller apparatus for a rotor used in the driving apparatus will be described below in detail with reference to the accompanying drawing. FIG. 1 is a graph showing the relationship between a moving speed v of a rotor, a peak current set signal P of a driving signal, and the excitation scheme of a driving current in a driving apparatus according to the present invention. FIG. 2 is a sectional view showing an image sensing apparatus. FIG. 3 is a block diagram showing an image sensing system using the image sensing apparatus. FIG. 4 is a block diagram showing a driving apparatus according to the first embodiment. FIG. 5 is a graph showing the currents and synthetic vector of the respective winding phases of a rotor driven by the driving apparatus. FIG. 6 is a graph showing the currents and synthetic vectors of the respective winding phases of the rotor driven by the driving apparatus in the stop state. FIG. 7 is a timing chart showing an example of the relationship between the peak current set signal and the driving signal of the driving apparatus. FIG. 8 is a timing chart showing another example of the relationship between the peak current set signal and the driving signal of the driving apparatus. FIG. 9 is a block diagram showing a driving apparatus according to the second embodiment. FIG. 10 is a block diagram showing a driving apparatus according to the third embodiment.

<Image Sensing Apparatus According to Present Invention and Image Sensing System Using the Same>

Referring to FIG. 2, an image sensing apparatus 10 according to the present invention is a combination dome camera with a transparent hemispherical cover. A stepping motor M1 for horizontal rotation is arranged inside. A stepping motor M2 for vertical rotation is arranged on a base connected to the stepping motor M1. A camera unit C is connected to the stepping motor M2. A driver section D for driving the stepping motors M1 and M2 is arranged in the image sensing apparatus 10.

The image sensing apparatus 10 constitutes an image sensing system as shown in FIG. 3. The image sensing apparatus 10 receives, from a controller 13 such as a computer apparatus, e.g., a control signal c such as a 64-step speed signal in the horizontal direction and a 64-step speed signal in the vertical direction and supplies a driving signal corresponding to the control signal c to the stepping motors M1 and M2.

On the other hand, an image sensing signal m is output from the camera unit C and supplied to a TV monitor 11 or recorder 12. Accordingly, a video image corresponding to the obtained image sensing signal m can be displayed on the TV monitor 11 or recorded in a storage area of the recorder 12. The user performs recording operation through the control panel of the recorder 12. In addition, the user can select the field to be sensed by appropriately rotating the camera unit C of the image sensing apparatus 10 by remote control from the controller 13. When the controller 13 and recorder 12 are connected, and all operations are controlled by a program in the controller 13, unmanned image sensing can be executed by a predetermined method to obtain a video image in, e.g., a shop.

The combination dome camera, i.e., the image sensing apparatus 10 has a mechanical structure which rotates the camera unit C in the horizontal and vertical directions. The present invention is used for a control technique of a combination dome camera using a stepping motor. However, the present invention is not limited to this and can widely be used for a control technique of a stepping motor.

In the image sensing apparatus 10, the camera unit C rotates in a predetermined direction at a rotational speed V in accordance with the control signal from the controller 13, as shown in FIG. 1. When a driving current by the peak current P as an optimum value is supplied by the driver section D (to be described later), optimum driving control can be performed. In addition, when an excitation scheme corresponding to the rotational speed V is given by the driver section D, optimum driving control can be performed. The rotational speed is obtained by an MPU 21 or the like from the current position or rotational speed of the motor on the basis of the speed signal c supplied from the external controller 13 or the like. The control method of the present invention will be described below in detail.

(Peak Current Setting by Driver Section D)

The weight of the driver section D in the power consumption distribution of the combination dome camera is large. Suppressing power consumption is important not only for size reduction of an apparatus but also for an increase in reliability and safety.

Even in a monitor camera having a driving circuit, the ratio of the stop time to the entire use time is high because of the characteristic feature of the camera. This embodiment places an emphasis on the above problem and provides a control technique for reducing power consumption.

<First Embodiment>

In the first embodiment, a stepping motor M1 for horizontal rotation and a stepping motor M2 for vertical rotation share a peak current set signal P.

Referring to the block diagram shown in FIG. 4, a driver section D has an MPU (Micro Processing Unit) 21 which receives a control signal c supplied from a controller 13, a switching section 29 which receives a peak current set value switching control signal from the MPU 21, and constant-current chopper motor drivers 22 to 25 to which a control signal d is supplied from the MPU 21 and the peak current set signal P from the switching section 29. The constant-current chopper motor drivers include the constant-current chopper motor driver 22 which supplies a driving current I_{VA} to the A-phase winding of the vertical rotation motor M2, the constant-current chopper motor driver 23 which supplies a driving current I_{VB} to the B-phase winding of the vertical rotation motor M2, the constant-current chopper motor driver 24 which supplies a driving current I_{HA} to the A-phase winding of the horizontal rotation motor M1, and the constant-current chopper motor driver 25 which supplies a driving current I_{HA} to the B-phase winding of the horizontal rotation motor M1.

Functionally, the MPU 21 has an excitation scheme determining section and a peak current set signal and control signal determining section.

Each of the constant-current chopper motor drivers 22 to 25 has a constant-current control nonlinear A/D converter 26 which receives the control signal d from the MPU 21, a D/A converter reference input section 27 which receives the peak current set signal P from the switching section 29, and a PWM chopper constant-current circuit 28 which outputs a driving current.

In this structure, if the stepping motor is a bipolar stepping motor, the rotation position is determined by a magnetic flux generated in each of the windings in the A- and B-phases. That is, the stepping motor moves to a position indicated by a synthetic vector based on the ratio of currents supplied to the windings. FIG. 5 shows this situation. In 2-phase excitation, 100% currents are supplied to both the A- and B-phases, and only the polarities are different. In the 2-phase excitation, the motor rotates stepwise from a position of 45° at a step width of 90°. There is also a microstep scheme which finely controls the synthetic vector within the range of 0° to 90°. Theoretically, the excitation currents of the A- and B-phases are sinusoidally changed while keeping them 90° out of phase, thereby obtaining a completely smooth locus.

The larger the absolute value of the synthetic vector becomes, the larger the rotation torque generated becomes. In the prior art, the motor is held at the current position by simply stopping current control.

However, the torque necessary in the dome camera is not constant. Especially, a large torque is required in the acceleration/deceleration mode. Hence, the required torque in the stop state is very small. In this embodiment, the excitation current switching section 29 is provided, as shown in FIG. 4, to perform peak current set signal switching control in the stop and driving modes. In the stop state, the current values of the A- and B-phases are decreased while maintaining their current ratio immediately before stop. It is important here to decrease the excitation currents while maintaining the current ratio of their phases, instead of simply decreasing the currents. When the current ratio is maintained, the direction of synthetic vector does not change. Hence, the motor holds its rotation angle, as shown in FIG. 6. Only the torque can be decreased.

Accordingly, the magnitude of the driving current when the motor stops can be suppressed in accordance with the timing of a peak current set signal P_{H}, as shown in the excitation current charts of FIGS. 7 and 8. Hence, the power consumption of the dome camera in which the motor stands still for a very long time can be largely reduced.

Even when the motor stops, the current cannot be zero. This is because a stepping motor of permanent magnet type moves to a position where the detent torque is large.

In the graph shown in FIG. 1, this embodiment corresponds to a timing T7 when the current consumption is suppressed to a peak current P6.

<Second Embodiment>

In the second embodiment, vertical rotation and horizontal rotation are independently controlled.

Referring to FIG. 9, a switching section 30 for a vertical motor and a switching section 31 for a horizontal motor are independently arranged. The remaining structure is the same as in FIG. 4.

Generally, the frequency of control of a combination dome camera is vertical direction<<horizontal direction. That is, a period in which the horizontal motor is rotating but the vertical motor stops is very long. When current control is performed separately for the horizontal and vertical directions, power consumption can be more effectively reduced.

<Third Embodiment>

In the third embodiment, in addition to peak current setting in the stationary state, the peak current set value is finely set in accordance with various rotational speeds, as shown in FIG. 1.

Referring to FIG. 10, D/A converters 32 having an electronic volume function are arranged independently for horizontal and vertical motors. More specifically, in the first and second embodiments, motor operation states are roughly classified into the stop state and rotation state. However, the rotation state can further be classified into acceleration, deceleration, and constant speed rotation, which require different torques to satisfy the performance of the product. Even in constant speed rotation, the necessary torque changes depending on the rotational speed. In the third embodiment, the peak excitation current is more finely controlled in various operation states by a peak current set signal P_{V} using the D/A converters 32 having an electronic volume function. With this arrangement, more efficient power consumption can be realized.

More specifically, referring to FIG. 1, at an ultra low speed T1, the rotational speed is very low, though the moving time is long. Slight vibration leads to a shake of the dome camera which often uses the zoom lens, resulting in a large influence on video image. The vibration is suppressed by setting a large torque. To do this, the peak current P is set to the maximum value (P1) such that a moving video image with little blur can be obtained at an ultra low speed.

Next, in an acceleration mode T2, to set a peak current P2 having a magnitude shown in FIG. 1, control is performed by supplying the peak current set signal P2 from the D/A converter 32.

In an acceleration (high) mode T3, a peak current P3 which is larger than the peak current P2 in the acceleration mode T2 but not maximum is supplied to accelerate at a larger torque. When the speed comes close to the highest speed, a maximum peak current P4 equal to the current in the highest speed mode is supplied.

In a highest speed mode T4, control is performed by supplying the maximum peak current P4.

In a deceleration (high) mode T5, to sufficiently suppress the inertia of the maximum speed of the motor, deceleration of the motor is controlled by supplying the maximum peak current P4.

In a deceleration mode T6, control is performed by supplying a peak current P5 having the same magnitude as that of the peak current P2 in the acceleration mode T2.

Finally, in a stop state T7, to suppress power consumption in the stationary state that occurs quite often in the combination dome camera, control is performed by supplying a peak current P6 that is minimum but not zero.

In this way, the peak current value of the driving current is controlled by finely setting the peak current set signal P in accordance with the rotational speed of the motor. This makes it possible to control and optimize the driving current in accordance with the rotational speed.

<Fourth Embodiment>

In the fourth embodiment, the excitation scheme is changed in accordance with the rotational speed such that the driving current is supplied by an optimum excitation scheme.

As the basic concept, when the speed is low, microstep excitation is performed to obtain a smooth moving video image by the camera. In a high-speed rotation mode, the motor is driven by 2-phase excitation with a large step angle to generate a large torque and reduce the load on the MPU.

Assume that the motor and mechanism are built by the following components.

Motor: bipolar stepping motor, 200 steps

(1.8°/step: 2-phase excitation)

Mechanical reduction ratio: 1/40

In the above arrangement, when the motor is rotated by 2-phase excitation, the camera body makes one revolution by 200×400=8,000 steps. At this time, the moving angle per step is 360°/8000 =0.045°.

The dome camera uses a zoom lens with a high magnification. The horizontal view angle at the maximum magnification is generally 1° to 2°. Assume that the horizontal view angle in the telephoto state is 1°. In the above arrangement, the horizontal view angle corresponds to about 42 steps.

With this number of steps, shake occurs obviously when the camera image moves in the horizontal direction. In addition, for the operability of the product, the minimum speed must be set such that the moving time corresponding to the horizontal view angle becomes about 10 sec. For this reason, when the image is visually observed, the shake in movement becomes more conspicuous.

To solve this problem, in the low-speed driving mode, the motor is driven by 1/16 microstep. Numerical values in this case are as follows.

The number of steps for one revolution of the camera body=200×40×16=128,000 steps

The moving angle per step=360°/128000 =0.0028°

The number of steps per horizontal view angle in the maximum telephoto state=356

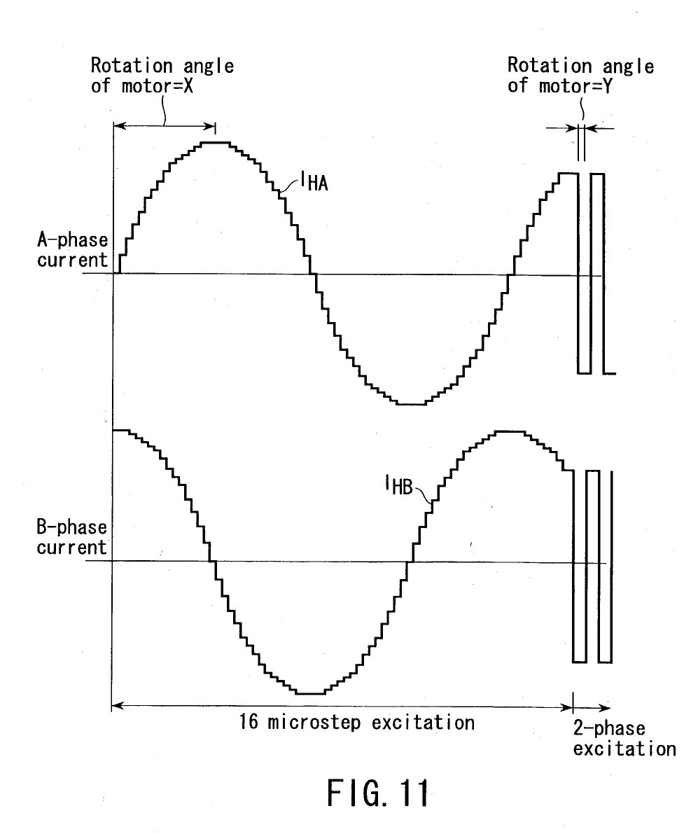

As is apparent, all numerical values are increased to 16 times. The rotational angle of 1/16 microstep=X and the rotational angle of 2-phase excitation=Y shown in FIG. 11 indicate the same moving amount. That is, in 1/16 microstep, the moving angle corresponding to one step of 2-phase excitation is divided into 16 parts. With this arrangement, smooth movement through the angle of view can be realized.

On the other hand, as general performance in a high-speed rotation mode, the camera body must be rotated at a high speed of about 250°/s to 360°/s. When excitation is performed by fixing the above-described 1/16 microstep, 128,000-step control is required until the camera makes one revolution. At this time, the processing period of the MPU is T=about 7.8 μs (1/128000). To realize this, generally, timer interrupt control is used. Since the motor must be driven at a period of 7.8 μs, coordinate calculation for the current and target position and acceleration/deceleration operation must be executed, and the horizontal and vertical motors must be independently controlled, the load on the MPU doubles. The above control unit uses a built-in MPU. The load is very large, and an expensive high-speed MPU is necessary. When high-speed driving is performed by 1/16 microstep, the high-speed rotation performance degrades because of a shortage of torque. Hence, when the excitation scheme is fixed to 1/16 microstep, a degradation in high-speed specifications cannot be avoided.

When 2-phase excitation is used in the high-speed rotation mode,

T=about 125 μs (1/8000)

Since the load on the MPU is largely reduced, and the rotation torque can be increased, high-speed rotation is possible.

For view angle movement in the high-speed rotation mode, if the wide-angle side in the zoom lens is set to 40°, the image moves from the left end to the right end of the screen in a short time of about 0.1 sec in the high-speed rotation (360°/s) mode. Hence, no shake by 2-phase excitation can be visually observed.

As described above, in the fourth embodiment, microstep excitation with a high resolving power is used in the lowest speed mode, and the motor is driven by 2-phase excitation in the high speed mode. When the excitation scheme is changed in accordance with the speed, both the smoothness at a low speed and the high-speed rotation can be satisfied.

<Fifth Embodiment>

The fifth embodiment provides a method of finely changing the excitation scheme in accordance with the rotational speed of the motor. As shown in FIG. 1, the excitation scheme is switched stepwise in accordance with the rotational speed from an ultra low speed T1 to a highest speed T4 and deceleration mode T6.

More specifically, the phase excitation scheme and vibration amount have a relationship given by

vibration amount=2-phase excitation>1/2-phase

excitation>1/4 microstep>1/8 microstep>1/16 microstep . . .

The vibration amount equals the noise amount of the product. The noise of the product is preferably low, as a matter of course. When phase excitation is changed in accordance with the rotational speed of the camera by using microstep with a high resolving power in the intermediate speed range controllable by the MPU and gradually changing the excitation scheme to rough microstep at the critical point of the control speed of the MPU, stable driving with lower noise can be realized.

<Sixth Embodiment>

In the sixth embodiment, the above-described processing of setting the peak current in accordance with the rotational speed (first to third embodiments) and processing of switching the excitation scheme in accordance with the rotational speed (fourth and fifth embodiments) are simultaneously executed.

This specifies the processing shown in FIG. 1. When the processing of setting the peak current and the processing of changing the excitation scheme are simultaneously executed, optimum motor control processing can be performed, unlike the conventional apparatus. This most efficiently realizes motor control operation desired by the user. A high-quality video signal of a combination dome camera can be obtained at low power consumption through an ultra low speed mode (T1), stationary mode (T7), acceleration mode (T2 and T3), deceleration mode (T5 and T6), and highest speed mode (T4).

Those skilled in the art can implement the present invention by the above-described embodiments. Those skilled in the art can easily make various changes and modifications of these embodiments and can apply them to various embodiments without any inventive capability. The invention is therefore not limited to the above-described embodiments and incorporates a broader aspect without inconsistency to the disclosed principle and novel features.

As has been described above, the present invention can provide a controller apparatus which finely sets the peak current of the driving current in accordance with the rotational speed of the motor and finely switches the excitation scheme to obtain a control characteristic optimum for the rotational speed, a driving apparatus, an image sensing apparatus using these apparatuses, and methods thereof. Accordingly, a combination dome camera which provides a high-quality image sensing signal while suppressing power consumption can be implemented.

What is claimed is:

1. A controller apparatus for a rotor, comprising:
an excitation scheme determining section which receives a speed signal from an external device, determines a rotational speed of an external rotor on the basis of the speed signal, and determines an excitation scheme in correspondence with the rotational speed;
a peak current set signal generating section which generates and outputs a peak current set signal which sets a peak current of a driving current to rotate the rotor in accordance with the rotational speed; and
a control signal generating section which generates and outputs a control signal by the excitation scheme determined by the excitation scheme determining section in accordance with the rotational speed determined by the excitation scheme determining section.

2. An apparatus according to claim 1, wherein when the rotational speed should be set to zero to stop the rotor, the peak current set signal generating section sets the peak current to a value smaller than a maximum value.

3. An apparatus according to claim 1, wherein the peak current set signal generating section generates the peak current set signal so as to change a value of the peak current of the driving current in accordance with an operation state of the rotor.

4. An apparatus according to claim 1, wherein the excitation scheme determining section uses a microstep excitation scheme when the rotor rotates at a first rotational speed, and a 2-phase excitation scheme when the rotor rotates at a second rotational speed higher than the first rotational speed.

5. An apparatus according to claim 1, wherein the excitation scheme determining section changes determination of the excitation scheme from one to the other of at least two schemes of 1/16 microstep, 1/8 microstep, 1/4 microstep, 1/2-phase excitation, and 2-phase excitation in accordance with a change in rotational speed of the rotor.

6. An apparatus according to claim 1, wherein the peak current set signal generating section sets a first peak current value when the rotor is rotated at a first rotational speed, and sets a second peak current value larger than the first peak current value when the rotor is rotated at a second rotational speed lower than the first rotational speed.

7. An apparatus according to claim 1, wherein the peak current set signal generating section sets a maximum peak current value in a torque deceleration mode of the rotor.

8. An apparatus according to claim 1, wherein
the apparatus further comprises a plurality of excitation scheme determining sections which receive a plurality of speed signals from the external device to control driving of a plurality of rotors and correspond to the plurality of rotors based on the plurality of speed signals, a plurality of peak current set signal generating sections, and a plurality of control signal generating sections, and
driving of the plurality of rotors is controlled.

9. A driving apparatus comprising:
an excitation scheme determining section which receives a speed signal from an external device, determines a rotational speed of an external rotor on the basis of the speed signal, and determines an excitation scheme in correspondence with the rotational speed;
a peak current set signal generating section which generates and outputs a peak current set signal which sets a peak current of a driving current to rotate the rotor in accordance with the rotational speed;
a control signal generating section which generates and outputs a control signal by the excitation scheme determined by the excitation scheme determining section in accordance with the rotational speed determined by the excitation scheme determining section; and
a driver which receives the peak current set signal from the peak current set signal generating section and the control signal from the control signal generating section, generates a driving current on the basis of the peak current set signal and control signal, and supplies the driving current to the rotor to drive the rotor.

10. An apparatus according to claim 9, wherein when the rotational speed should be set to zero to stop the rotor, the peak current set signal generating section sets the peak current to a value smaller than a maximum value.

11. An apparatus according to claim 9, wherein the peak current set signal generating section variably sets the peak current of the driving current in accordance with an operation state of the rotor.

12. An apparatus according to claim 9, wherein the excitation scheme determining section uses a microstep excitation scheme when the rotor rotates at a first rotational speed, and a 2-phase excitation scheme when the rotor rotates at a second rotational speed higher than the first rotational speed.

13. An apparatus according to claim 9, wherein the excitation scheme determining section changes determination of the excitation scheme from one to the other of at least two schemes of 1/16 microstep, 1/8 microstep, 1/4 microstep, 1/2-phase excitation, and 2-phase excitation in accordance with a change in rotational speed of the rotor.

14. An apparatus according to claim 9, wherein the peak current set signal generating section sets a first peak current value when the rotor is rotated at a first rotational speed, and sets a second peak current value larger than the first peak current value when the rotor is rotated at a second rotational speed lower than the first rotational speed.

15. An apparatus according to claim 9, wherein the peak current set signal generating section sets a maximum peak current value in a torque deceleration mode of the rotor.

16. An apparatus according to claim 9, wherein
the apparatus further comprises a plurality of excitation scheme determining sections which receive a plurality of speed signals from the external device to control driving of a plurality of rotors and correspond to the plurality of rotors based on the plurality of speed signals, a plurality of peak current set signal generating sections, a plurality of control signal generating sections, and a plurality of drivers, and
the plurality of rotors are driven.

17. An image sensing apparatus which senses a video image in an arbitrary direction, comprising:
a camera unit which has at least an image sensing element to sense a video image in a predetermined direction and is rotated to sense the video image in the arbitrary direction;
a motor which is connected to the camera unit and rotated to direct the camera unit in the arbitrary direction;
an excitation scheme determining section which receives a speed signal from an external device, determines a rotational speed of the motor on the basis of the speed signal, and determines an excitation scheme in correspondence with the rotational speed;
a peak current set signal generating section which generates and outputs a peak current set signal which sets a peak current of a driving current to rotate the motor in accordance with the rotational speed;
a control signal generating section which generates and outputs a control signal by the excitation scheme determined by the excitation scheme determining section in accordance with the rotational speed determined by the excitation scheme determining section; and
a driver which receives the peak current set signal from the peak current set signal generating section and the control signal from the control signal generating section, generates a driving current on the basis of the peak current set signal and control signal, outputs the driving current to the motor to drive the motor, and causes the motor to direct the camera unit in the arbitrary direction corresponding to the speed signal.

18. A control method for a rotor, comprising:
receiving a speed signal, determining a rotational speed of the rotor on the basis of the speed signal, and determining an excitation scheme in correspondence with the rotational speed;
generating and outputting a peak current set signal which sets a peak current of a driving current to rotate the rotor in accordance with the rotational speed; and
generating and outputting a control signal by the determined excitation scheme in accordance with the determined rotational speed.

19. A driving method for a rotor, comprising:
receiving a speed signal, determining a rotational speed of the rotor on the basis of the speed signal, and determining an excitation scheme in correspondence with the rotational speed;
generating and outputting a peak current set signal which sets a peak current of a driving current to rotate the rotor in accordance with the determined rotational speed;
generating and outputting a control signal by the determined excitation scheme in accordance with the rotational speed; and
generating a driving current to rotate the rotor on the basis of the peak current set signal and control signal and supplying the driving current to the rotor to drive the rotor.

20. An image sensing method of sensing a video image in an arbitrary direction, comprising:
in rotating a rotor to direct a camera unit in the arbitrary direction and causing the camera unit to perform image sensing, the camera unit having an image sensing element which senses a video image in a predetermined direction and being connected to the rotor, determining a rotational speed of the rotor on the basis of a speed signal received from an external device and determining an excitation scheme in correspondence with the rotational speed;
generating and outputting a peak current set signal which sets a peak current of a driving current to rotate the rotor in accordance with the determined rotational speed;
generating and outputting a control signal by the determined excitation scheme in accordance with the rotational speed; and
generating a driving current on the basis of the peak current set signal and control signal, supplying the driving current to the rotor to drive the rotor, and directing the camera unit in the arbitrary direction corresponding to the speed signal.

21. A controller apparatus for a rotor, comprising:
a control signal generating section which receives a speed signal from an external device, determines a rotational speed of an external rotor on the basis of the speed signal, and generates and outputs a control signal in accordance with the rotational speed; and
a peak current set signal generating section which generates and outputs a peak current set signal which sets a peak current of a driving current to rotate the rotor in accordance with the rotational speed determined by the control signal generating section, and when the rotational speed should be set to zero to stop the rotor, sets the peak current to a value smaller than a maximum value.

22. A controller apparatus for a rotor, comprising:
a control signal generating section which receives a speed signal from an external device, determines a rotational speed of an external rotor on the basis of the speed signal, and generates and outputs a control signal in accordance with the rotational speed; and
a peak current set signal generating section which generates and outputs a peak current set signal which sets a peak current of a driving current to rotate the rotor in accordance with the rotational speed determined by the control signal generating section so as to change a value of the peak current of the driving current in accordance with an operation state of the rotor.

23. A controller apparatus for a rotor, comprising:
an excitation scheme determining section which receives a speed signal from an external device, determines a rotational speed of an external rotor on the basis of the speed signal, and determines to use a microstep excitation scheme when the rotor rotates at a first rotational speed and a 2-phase excitation scheme when the rotor rotates at a second rotational speed higher than the first rotational speed; and
a control signal generating section which generates and outputs a control signal by the excitation scheme determined by the excitation scheme determining section in accordance with the rotational speed determined by the excitation scheme determining section.

24. A controller apparatus for a rotor, comprising:
an excitation scheme determining section which receives a speed signal from an external device, determines a rotational speed of an external rotor on the basis of the speed signal, and determines an excitation scheme by changing the excitation scheme from one to the other of 1/16 microstep, 1/8 microstep, 1/4 microstep, 1/2-phase excitation, and 2-phase excitation in accordance with a change in magnitude of the rotational speed; and
a control signal generating section which generates and outputs a control signal by the excitation scheme determined by the excitation scheme determining section in accordance with the rotational speed determined by the excitation scheme determining section.
